(19) United States
(12) Patent Application Publication
(10) Pub. No.: US 2012/0084460 A1
(43) Pub. Date: Apr. 5, 2012

(54) METHOD AND SYSTEM FOR DYNAMIC TRAFFIC STEERING

(75) Inventors: Shaun McGinnity, Belfast (IE); Stephen Wright, Belfast (IE); Patrick McGleenon, Belfast (IE); Ramkumar Venkataramani, Sunnyvale, CA (US); Mark Delany, Redwood City, CA (US)

(73) Assignee: OPENWAVE SYSTEMS INC., Redwood City, CA (US)

(21) Appl. No.: 12/985,686

(22) Filed: Jan. 6, 2011

Related U.S. Application Data
(60) Provisional application No. 61/389,702, filed on Oct. 4, 2010.

(51) Int. Cl. G06F 15/16

(52) U.S. Cl. 709/242

(57) ABSTRACT

A method and system for dynamic traffic steering is described. In one embodiment, a method for dynamic traffic steering involves receiving a request for content at a steering component, comparing information in the request with steering criteria in the steering component, steering the request based on the comparing, and continuously updating the steering criteria based on requests that are subsequently received at the steering component. Other embodiments are also described.

### CROSS-REFERENCE TO RELATED APPLICATION

This application is entitled to the benefit of provisional U.S. patent application Ser. No. 61/389,702, filed Oct. 4, 2010.

### BACKGROUND

Advances in Internet and wireless technologies have triggered an exponential upsurge in the amount of content that is accessible by wireless devices. Different content types, such as video, audio, and webpages, pose different demands for quality of service (QOS). In order to improve QOS, traffic can be steered to certain delivery optimization resources. Typically, traffic is steered to optimization resources according to a static set of steering rules. For example, a static set of Uniform Resource Locators (URLs) is used to steer HTTP requests for video content. However, the landscape of Internet delivered video changes rapidly, with hot websites and videos appearing and disappearing relatively quickly. Therefore, a static set of steering rules can become out-of-date in a short duration of time. When a static set of steering rules becomes out-of-date, some video data may be delivered to wireless devices without the benefit of the optimization resources that are available to improve QOS.

### SUMMARY

Embodiments of a method are described. In one embodiment, a method for dynamic traffic steering is described. The method for dynamic traffic steering involves receiving a request for content at a steering component, comparing information in the request with steering criteria in the steering component, steering the request based on the comparing, and continuously updating the steering criteria based on requests that are subsequently received at the steering component. In another embodiment, a method for dynamic traffic steering is described. The method for dynamic traffic steering involves receiving a request for content at a steering component, comparing a destination Internet Protocol (IP) address of the request with a list of IP addresses, if the destination IP address of the request is on the list of IP addresses, sending the request to an optimization platform, transmitting the request from the optimization platform to a content server that is identified in the request, receiving a response to the request from the content server at the optimization platform, and optimizing the response for delivery at the optimization platform, if the destination IP address of the request is not on the list of IP addresses, sending the request to a discovery proxy, transmitting the request for content from the discovery proxy to the content server that is identified by the request, receiving the response to a request from the content server at the discovery proxy, scanning the response at the discovery proxy to determine whether or not the response contains video content, and updating the steering criteria in response to the determination that is made by the discovery proxy, and continuously updating the steering criteria based on requests that are subsequently received at the steering component. Other embodiments of a method are also described.

Embodiments of a traffic controller for dynamic traffic steering are also described. In one embodiment, a traffic controller for dynamic traffic steering includes a steering component configured to maintain steering criteria for steering requests for content, an optimization platform configured to optimize delivery of content requested by at least one of the requests for content, and a discovery proxy configured to perform a content discovery process to update the steering criteria. Other embodiments of a traffic controller for dynamic traffic steering are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a content delivery system.

FIG. 2 depicts an embodiment of the traffic controller of FIG. 1.

FIG. 3 depicts the Open Systems Interconnection (OSI) model.

FIG. 4 depicts an exemplary IP packet.

FIG. 5 depicts an exemplary Hypertext Transfer Protocol (HTTP) GET request message.

FIG. 6 depicts an exemplary HTTP response message.

FIGS. 7-11 illustrate examples of operations of the traffic controller depicted in FIG. 2.

FIG. 12 depicts another embodiment of the traffic controller of FIG. 1.

FIG. 13 depicts a computer that includes a processor, memory, and a communications interface.

FIG. 14 is a process flow diagram of a method for dynamic traffic steering in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

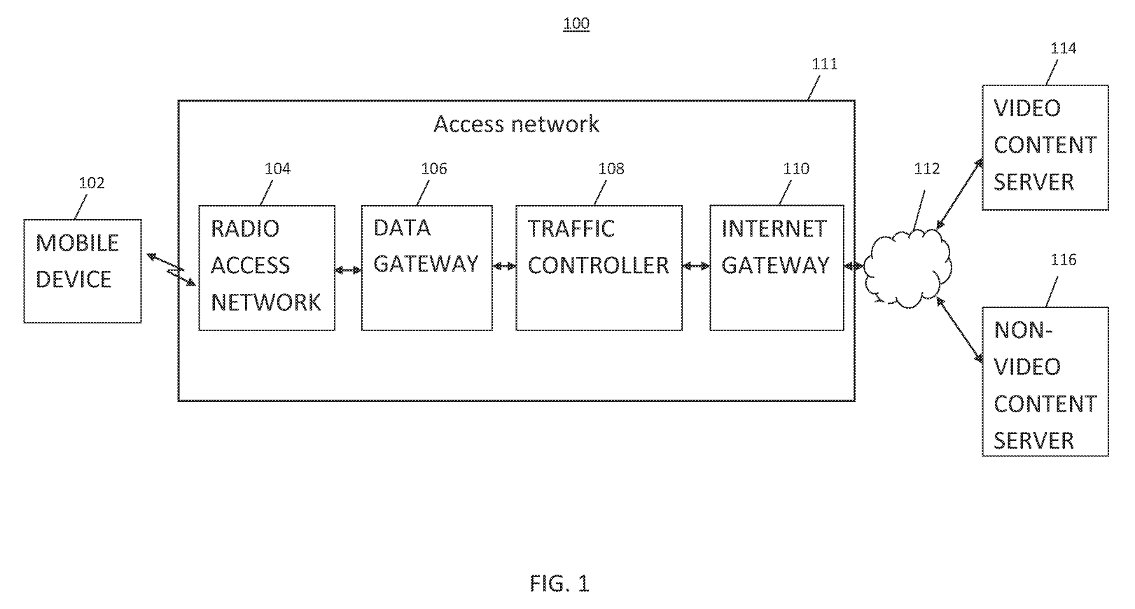

FIG. 1 depicts a schematic block diagram of one embodiment of a content delivery system 100. The content delivery system 100 depicted in FIG. 1 includes a mobile device 102, a radio access network 104, a data gateway 106, a traffic controller 108, an Internet gateway 110, the Internet 112, a video content server 114, and a non-video content server 116. Although the content delivery system is depicted and described with certain components and functionality, other embodiments of the content delivery system may include fewer or more components to implement less or more functionality. For example, the content delivery system may include more than one mobile device, more than one radio access network, more than one data gateway, more than one Internet gateway, more than one video content server, and/or more than one non-video content server.

The mobile device 102 of the content delivery system 100 is typically a handheld wireless device, such as a cell phone, a mobile phone, a smartphone, a pad computer, a Personal Digital Assistant (PDA), a handheld gaming device etc, which can wirelessly communicate using radio frequency (RF) communications signals. The mobile device can support various different RF communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that present disclosure is not limited to the cited wireless communications protocols. The mobile device is configured to request content from the video content server 114 and/or the non-video content server 116 on behalf of a user and to render received content for displaying to the user. The user may be a single person, multiple persons, other entity or entities.

The radio access network 104 of the content delivery system 100 is configured to facilitate radio communications between the mobile device 102 and a core network that includes the data gateway 106, the traffic controller 108, the Internet gateway 110, the Internet 112, the video content server 114, and the non-video content server 116. In an embodiment, the radio access network includes one or more base stations to facilitate communications among mobile devices that are within a communication range of the base stations. Each base station has at least one RF transceiver and the base stations communicate with the mobile devices using RF communication signals. The radio access network facilitates network communications among multiple mobile stations within the same radio access network and between mobile stations in other radio access networks and provides interfaces to facilitate communications with other entities, such as a Public Switched Telephone Network (PSTN), a Wide Area Network (WAN), the Internet, Internet servers, hosts, etc., which are outside of the radio access network. In an embodiment, the network elements depicted in FIG. 1 are part of a wireless network that is operated by a single wireless service provider.

Data signals communicated between the mobile device 102 and the radio access network 104 include, but are not limited to, analog and/or digital RF signals (i.e., radio waves) for any type of communication mode, including text messaging, multimedia messaging, voice calling, and Internet browsing. The radio access network can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that present disclosure is not limited to the cited wireless communications protocols.

Although the content delivery system 100 depicted in FIG. 1 includes the mobile device 102 and the radio access network 104, in other embodiments, the content delivery system includes a wired device instead of the mobile device and a wired communications network instead of the radio access network. The wired device may be a wired communications device that is configured to request content from the video content server 114 and/or the non-video content server 116 on behalf of a user and to render received content for displaying to the user. The wired communications network can facilitate communications between the wired communications device and the core network that includes the data gateway 106, the traffic controller 108, the Internet gateway 110, the Internet 112, the video content server 114, and the non-video content server 116. The wired device may be, for example, a computer equipped with an Ethernet card and the wired communications network may be an Ethernet local area network (LAN). In some embodiments, the content delivery system includes a combination of at least one mobile device, at least one radio access network, at least one wired device, and at least one wired communications network.

The data gateway 106 of the content delivery system 100 configures outgoing data access requests for use with one or more networks and configures incoming data for use by or display on the mobile device 102. As shown, the data gateway interfaces directly with the radio access network 104 and the traffic controller 108, although other embodiments may include other intermediate functional elements. In one embodiment, the data gateway uses GPRS Tunneling Protocol (GTP) to communicate with the radio access network. Other embodiments may use other communications protocols. Other conventional operations of the data gateway are known. For example, the data gateway enables users of mobile devices to roam between cells, for example, to move between different locations within the radio access network, by tracking the mobile device's identity across the network. The data gateway may also provide authentication and data formatting functions.

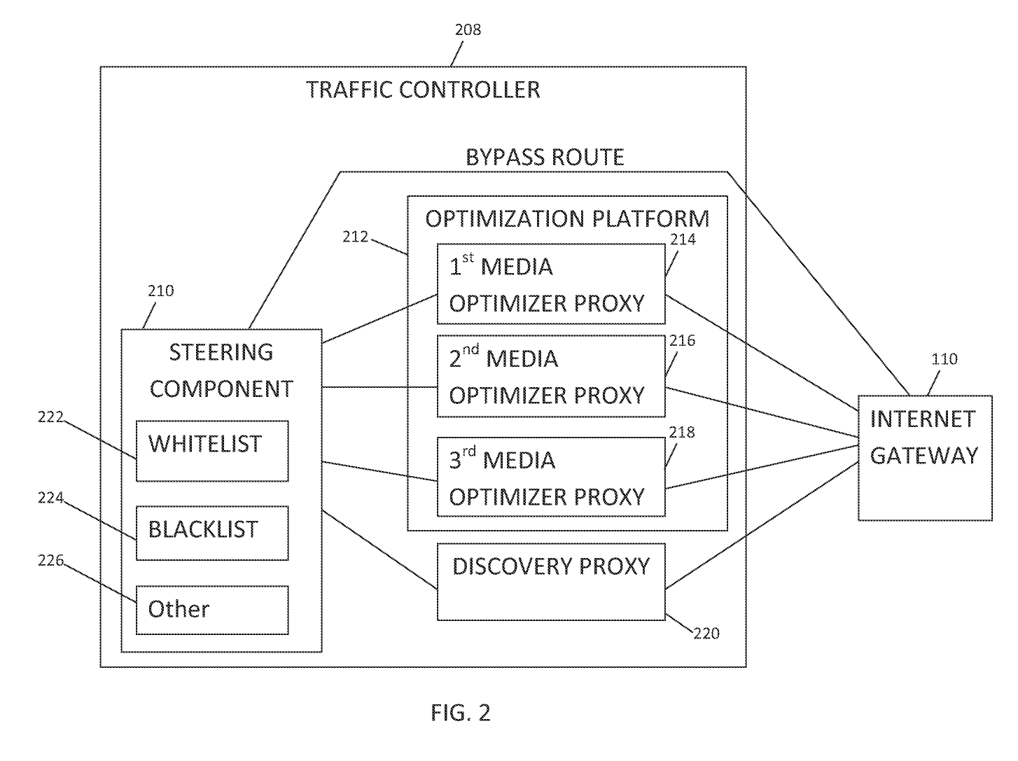

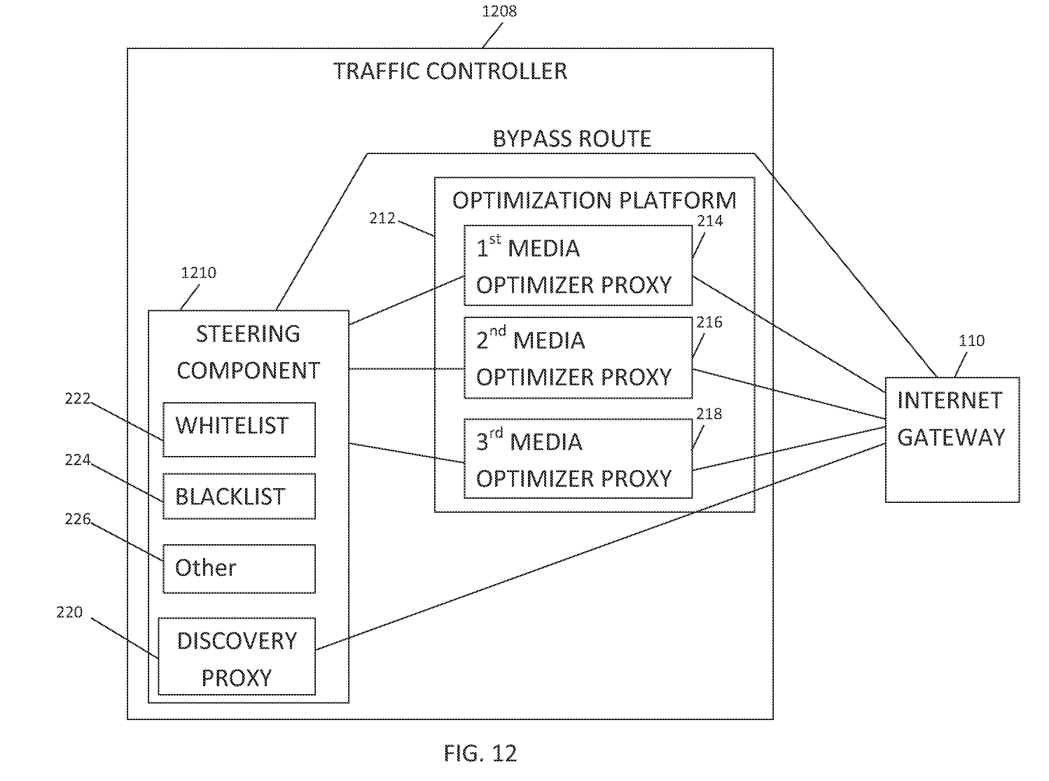

The traffic controller 108 of the content delivery system 100 is configured to monitor requests for content that are sent from the mobile device 102 to the video content server 114 and/or the non-video content server 116, to determine the content types of the requests, and to optimize the delivery of the requested content. The traffic controller acts as a proxy server between the mobile device and the video content server and/or the non-video content server and dynamically steers the traffic between the mobile device and the video content server and/or the non-video content server. FIG. 2 and FIG. 12 depict two embodiments of the traffic controller of FIG. 1.

In the embodiment depicted in FIG. 2, a traffic controller 208 includes a steering component 210, an optimization platform 212 that includes a first media optimizer proxy 214, a second media optimizer proxy 216, and a third media optimizer proxy 218, and a discovery proxy 220. Although the traffic controller is depicted and described with certain components and functionality, other embodiments of the traffic controller may include fewer or more components to implement less or more functionality. For example, the traffic controller may include more than one discovery proxy and the optimization platform may include less than three media optimizer proxies or more than three media optimizer proxies. In an embodiment, components of the traffic controller 208 are distributed among different devices in a network. For example, the steering component, the optimization platform, and the discovery proxy can be located in separate network devices and/or separate networks. In another example, the first, second and third media optimizer proxies are located in separate network devices and/or separate networks. As yet another example, instead of the media optimizer proxies, the optimization platform may include at least one packet modifying entity. The package modifying entity can modify one or more packets carrying a request for content and/or one or more packets carrying a response to the request that is sent from the video content server 114 and/or the non-video content server 116. For example, the package modifying entity may insert data into a packet, translate data in a packet, and/or delete data in a packet. The packet modifying entity can be located anywhere in the data path between the mobile device 102 and the video content server and/or in the data path between the mobile device and the non-video content server.

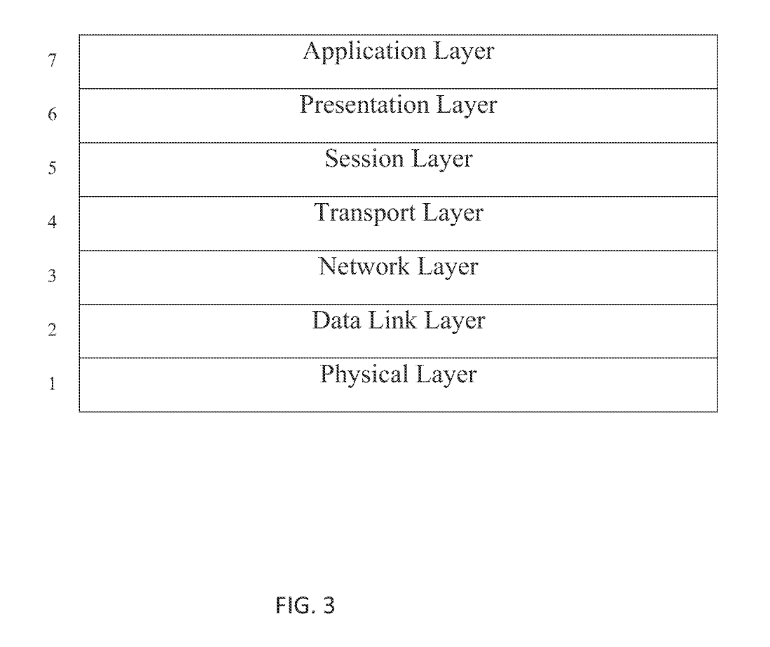

The steering component 210 of the traffic controller 208 is configured to maintain steering criteria for steering requests for content. The steering component may maintain steering criteria solely based on information from one layer of the Open Systems Interconnection (OSI) model, which is shown in FIG. 3, or based on information from more than one layer of the OSI model. As depicted in FIG. 3, the OSI model includes seven layers, which are Layer 1 (Physical Layer), Layer 2 (Data Link Layer), Layer 3 (Network Layer), Layer 4 (Transport Layer), Layer 5 (Session Layer), Layer 6 (Presentation Layer), and Layer 7 (Application Layer). In an embodiment, the steering component maintains steering criteria based on information found in at least one of Layer 3 (Network Layer,) Layer 4 (Transport Layer,) Layer 5 (Session Layer,) Layer 6 (Presentation Layer,) and Layer 7 (Application Layer) of the OSI model. For example, the steering component may maintain steering criteria that is solely or partially based on information from the Network Layer. In an embodiment, the steering component keeps a list of IP addresses that correspond to known video sites, such as YouTube.com, Google Videos, Metacafe.com, and Hulu.com, as the steering criteria. The steering component may store additional information such as IP address lifetime, destination port, source port, time-of-day, and day-of-week. The lifetime of an IP address is a time out period or an expiration date that the IP address will drop out of the steering criteria so that the IP address gets an opportunity for a re-evaluation by the discovery proxy 220 at least once every lifetime. The time-of-day is the time in a day that the steering component receives a request for content. The day-of-week is the day in a week that the steering component receives a request for content. Internet traffic may have a predictable traffic pattern with respect to the time-of-day and/or the day-of-week. The steering component can take advantage of the knowledge of the traffic pattern to make traffic steering decisions based on the time-of-day and/or day-of-week. For example, the evening may be a peak viewing time in which traffic loads are heavier. Thus, the steering component can steer a relatively large percentage of requests for delivery optimization in the evening. In another example, based on the day-of-week, the steering component can steer requests differently for week days and weekends. In an embodiment, the steering criteria may include a combination of IP addresses and port numbers that correspond to known video sites. In yet another embodiment, the steering criteria may include other IP header and/or network layer information that corresponds to known video sites. For example, the steering criteria may include an HTTP header, which identifies a potential video domain. The steering component can be installed at a customer premise, such as a data center of a wireless carrier. The steering criteria of different customer deployments of the steering component may be aggregated into a cloud service. In this case, the cloud service can provide initial steering criteria to a new customer deployment.

In the embodiment depicted in FIG. 2, the steering component 210 is connected to the Internet gateway 110 through the optimization platform 212, the discovery proxy, and through a bypass route. The steering component steers a request for content based on steering criteria contained in a whitelist 222, a blacklist 224, and an optional third category “other” 226. If a request for content matches information contained in the whitelist, the steering component directs the request to the optimization platform 212 for content delivery optimization. If a request for content matches information contained in the blacklist, the steering component does not direct the request to the optimization platform. Instead, the steering component directs the request to a bypass route, which does not include the optimization platform. If a request for content neither matches information contained in the whitelist nor matches information contained in the blacklist, the steering component directs the request to the discovery proxy 220. The discovery proxy implements a content discovery process in which a discovery proxy determines whether or not the returned content includes content of interest and adds information related to the request to either the whitelist or the blacklist. For example, if the returned content includes video, the discovery proxy adds the information of the request to the whitelist. If the returned content does not include video, the discovery proxy adds the information of the request to the blacklist.

In an embodiment, the whitelist 222, the blacklist 224 and the third category “other” 226 contain destination address information, e.g., destination IP addresses. If a request for content is destined to a destination that is on the whitelist, the steering component 210 directs the request to the optimization platform 212 for content delivery optimization. For example, the steer component may perform an IP address lookup by checking the destination IP address of the request against the whitelist. If a request for content is destined to a destination that is on the blacklist, the steering component does not direct the request to the optimization platform. Instead, the steering component directs the request to a bypass route. If a request for content is destined to a destination that is neither on the whitelist nor on the blacklist, the steering component directs the request to the discovery proxy 220. The discovery proxy implements the content discovery process in which the discovery proxy determines whether or not the returned content includes content of interest and adds information related to the request to either the whitelist or the blacklist. For example, at the start of a deployment of the traffic controller 208, the whitelist stored in the steering component contains a list of IP addresses of popular known video sites. In addition to the list of IP addresses of popular known video sites, the whitelist may include additional information such as IP address lifetime, destination port, source port, time-of-day. The steering component can check destination IP addresses of requests that are sent from the mobile device 102. If a request from the mobile device is destined to an IP address that is on the whitelist, the steering component directs the request to the optimization platform for video content delivery optimization. If a request from the mobile device is destined to an IP address that is not on the whitelist, the request is subjected to the content discovery process by steering the request to the discovery proxy. The discovery proxy implements the content discovery process in which the discovery proxy determines whether or not the returned content includes video content. If the discovery proxy determines that the returned content includes video content, the discovery proxy identifies the source of the video content. The discovery proxy then notifies the steering component with details about the video content source (e.g., the IP address), so that the steering criteria maintained in the steering component can be updated to include information about the newly discovered video content source. For example, the whitelist is updated to include the IP address of the newly discovered video content source. As a result, the next time there is a request for the newly discovered source, the request can be steered accordingly. In an embodiment, the whitelist is empty at the start of a deployment of the traffic controller. The empty whitelist is then populated by IP addresses that are learned by the discovery proxy. If the requested content does not include video content, the steering criteria maintained in the steering component can be updated to include the destination information of the request. For example, the destination IP address in the request is stored in a blacklist. In an embodiment, any future request for content that is destined to an IP address that is on the blacklist is sent to the Internet gateway 110 through the bypass route and is not directed to the optimization platform. The third category “other” may not be in the form of a list. Rather, the third category “other” can include all of the IP addresses that are neither on the whitelist nor on the blacklist. From the population of request addresses in the third category “other,” new entries are discovered for addition to either the whitelist or the blacklist.

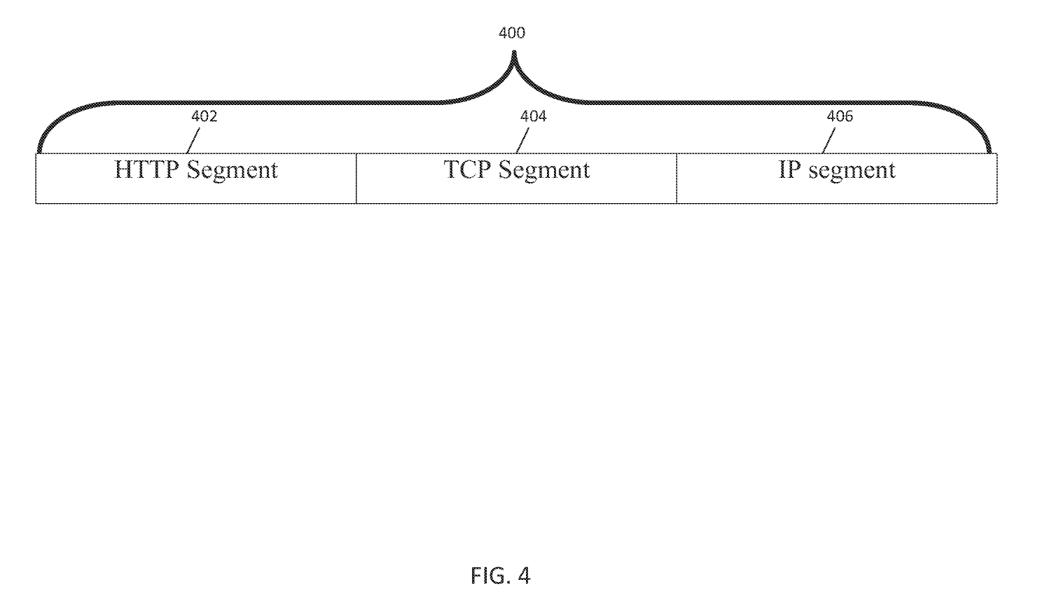

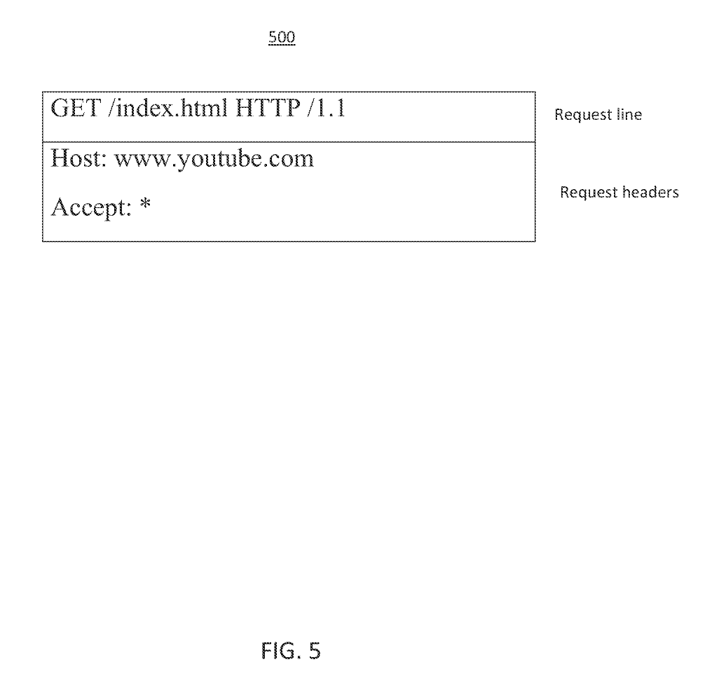

In an embodiment, the request for content that the steering component 210 receives is a single IP packet or multiple IP packets. FIG. 4 shows an exemplary request IP packet 400. As depicted in FIG. 4, the IP packet includes an HTTP segment 402, a Transmission Control Protocol (TCP) segment 404, and an IP segment 406. The HTTP segment includes an HTTP request message, such as an HTTP GET request message. FIG. 5 shows an exemplary HTTP GET request message 500. As depicted in FIG. 5, the HTTP GET request message includes a start line, which is also referred to as the request line, and request headers. The request headers contain a host such as www.youtube.com and acceptable response formats. The request line contains the “GET” operation, a request URL such as “index.html” that describes the resource of the host on which to perform the “GET” operation, and an HTTP version such as HTTP 1.1. In the exemplary HTTP GET request message, all response formats are acceptable. The TCP segment is also referred to as the TCP header. The TCP segment may include TCP information, such as source port, destination port, and TCP sequence number. The IP segment is also referred to as the IP header. The IP segment may include IP information such as source IP address, destination IP address, and time to live (TTL). Compared with a conventional traffic control approach that scans the URL or domain name in an HTTP GET request message, scanning the IP header for the destination IP address can be performed using only the network layer information. Therefore, the operation of getting into the HTTP GET request message to obtain the URL is no longer needed. As a result, dynamic traffic control can be performed in a manner that is very resource efficient.

The optimization platform 212 adds value to the content delivery system 100 with intelligent, device-aware and policy-aware delivery of video content and other content of interest, and reduces costs while increasing effective bandwidth. The optimization platform enables service providers to define subscriber level, time-of-day-based, or volume-based policies that influence the optimization decision. For example, with the optimization platform 212, service providers can identify video content in a response and optimize video content on demand, to reduce network cost while increasing utilization of existing network assets. The optimization platform can deliver the right amount of video data for smooth playback, but not too much at once, eliminate wasted bandwidth in case the user moves on to newer content before finishing watching the current video, increase network efficiency with a caching system, perform offline transcoding, and adjust the optimized media bit-rate delivered to the subscriber based on available network bandwidth. In the embodiment depicted in FIG. 2, the discovery proxy 220 and/or the optimization platform dynamically update(s) the whitelist and the blacklist of the steering component 210.

Each of the media optimizer proxies 214, 216, and 218 of the optimization platform 212 is configured to optimize video content for delivery to the mobile device 102 and/or to the radio access radio access network 104 according to criteria such as characteristics of the mobile device, the radio access network, and/or the video content. In an embodiment, each media optimizer proxy includes a transcoding module that is configured to encode video content that is being delivered into encoded video content, whose data size is smaller than the data size of the video content that is being delivered. The transcoding module may encode the video content based on the physical dimensions and resolution of the mobile device display, perceived bandwidth of the communications channel between the content and the mobile device, and supported codecs and delivery protocols of the mobile device. The transcoding module may also be configured to encode the content that is being delivered into encoded content that is more secure. By encoding the content that is being delivered into a smaller or more secure encoded form, the content delivery is optimized.

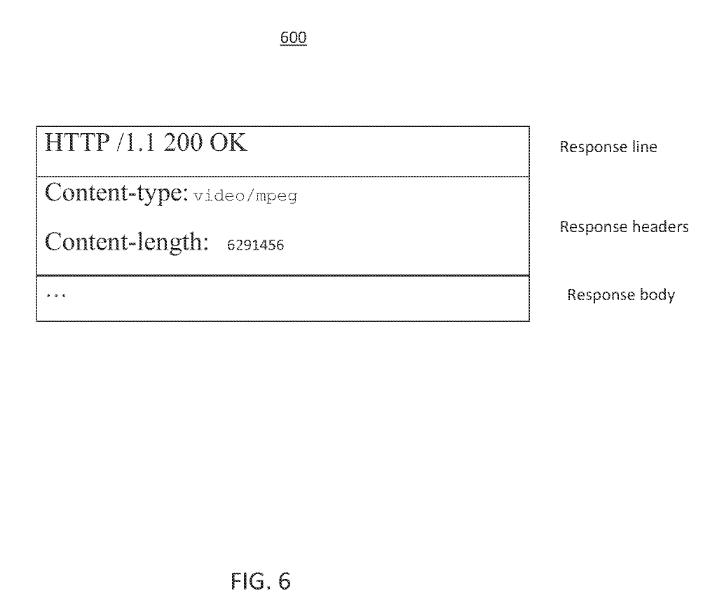

The response from the video server 114 and/or the non-video server 116, which may be a HTTP response, can be transmitted in a single IP packet or multiple IP packets. Each response IP packet may have a similar format to the exemplary request IP packet shown in FIG. 4. For example, the response IP packets may include an HTTP segment, a TCP segment, and an IP segment. The HTTP segment may include an HTTP response message. FIG. 6 shows an exemplary HTTP response message 600. As depicted in FIG. 6, the HTTP response message includes a start line, which is also referred to as the response line, response headers, and a response body. The response line contains an HTTP version such as HTTP 1.1, and a status code with reason phrase such as “200 OK.” The response headers contain response content information such as content-type and content-length. The content-type identifies the Internet media (MIME) type of the response body, which may be video, audio, image, or other content type. For example, the content-type may be “text/html,” which represents the response body is an HTML document. The content-type may be “text/plain,” which represents the response body is a document in plain text. The content-type may be “image/gif,” which represents that the response body is an image of type GIF. The content-type may be “audio/x-wav,” which represents that the response body contains WAV sound data. As shown in FIG. 6, the content-type is “video/mpeg,” which represents video in “Moving Picture Experts Group” (MPEG) format. The content-length identifies the length of the response body in bytes. In the HTTP response message of FIG. 6, the content-length is 6291456 bytes.

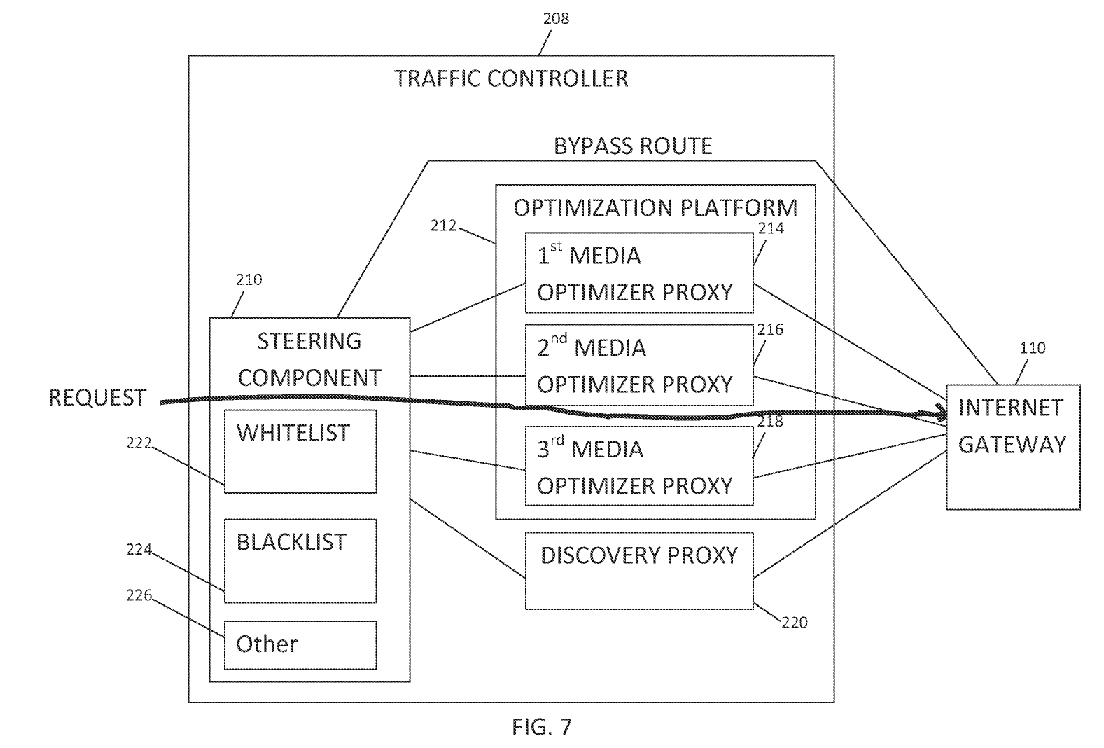

FIGS. 7-11 illustrate examples of operations of the traffic controller 208 depicted in FIG. 2. In the example illustrated in FIG. 7, the steering component 210 receives a request for content from an interested party, such as the mobile device 102. The steering component checks the IP header of the request message for the destination IP of the request. If the request is destined to a video source whose IP address is on the whitelist 222, e.g., the destination IP address of the request matches one of the addresses on the whitelist, the steering component sends the request for content through the optimization platform 212 to the Internet gateway 110. The steering component may check other information in the request message with the information in the whitelist, such as IP address lifetime, destination port, source port, time-of-day. The Internet gateway 110 transmits the requests to the video content server 114 (shown in FIG. 1) through the Internet 112 (shown in FIG. 1).

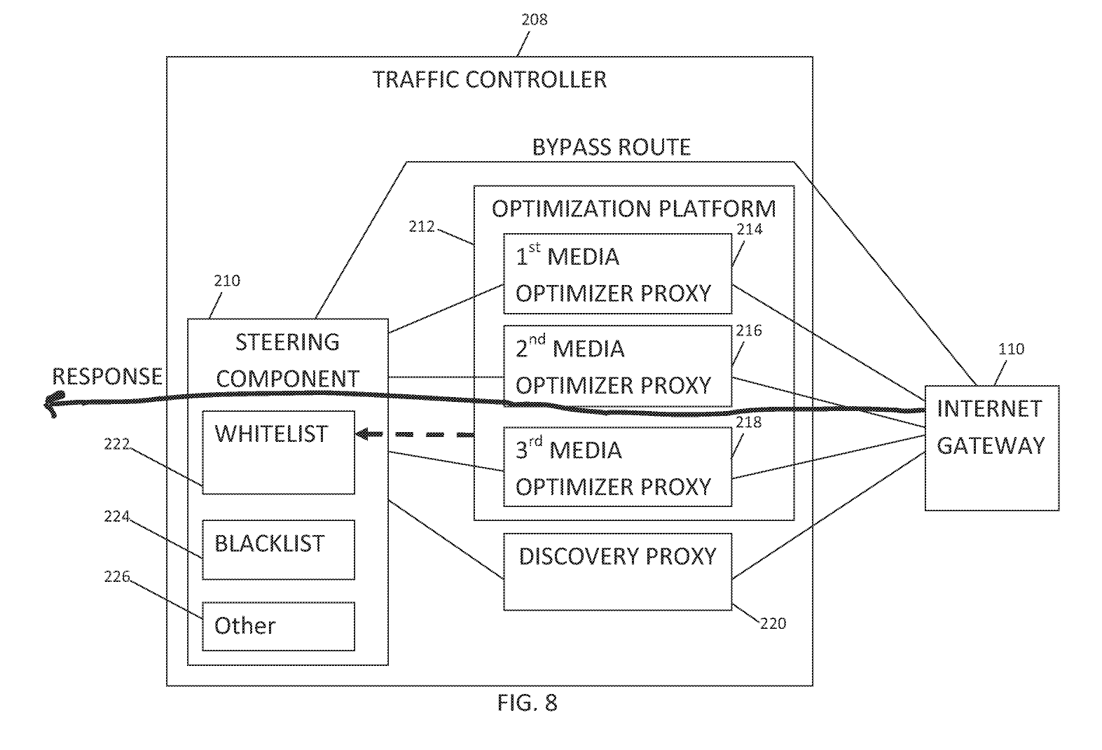

In the operation example illustrated in FIG. 8, the video content server 114 (shown in FIG. 1) sends a response that contains the requested video content through the Internet 112 (shown in FIG. 1) to the Internet gateway 110. The Internet gateway transmits the video content to the media optimizer proxies 214, 216, 218 of the optimization platform 212. The optimization platform sends the optimized video content to the mobile device 102. In an embodiment, at least one of the media optimizer proxies sends feedback information with respect to the whitelist 222 to the steering component and the steering component dynamically adjusts the whitelist. For example, the media optimizer proxies may feed performance indicators and other characteristics indicators to the steer component, which in turn adjusts the whitelist to adapt to system load or efficacy. In another embodiment, at least one of the media optimizer proxies reduces the scope of the whitelist, for example, reduces the number of the video sources on the whitelist. This may happen when one of the media optimizer proxies receives more video traffic than it can handle. In this case, although the volume of optimized video traffic may be reduced because some video sources have been removed from the whitelist, the optimization platform functions dynamically regardless of the video traffic mix. The media optimizer proxies may feed performance indicators and other characteristics indicators to a feedback agent (not shown), which in turn adjusts the whitelist and/or the blacklist to adapt to system load or efficacy. The feedback agent may be an independent component or may be embedded in the media optimizer proxies.

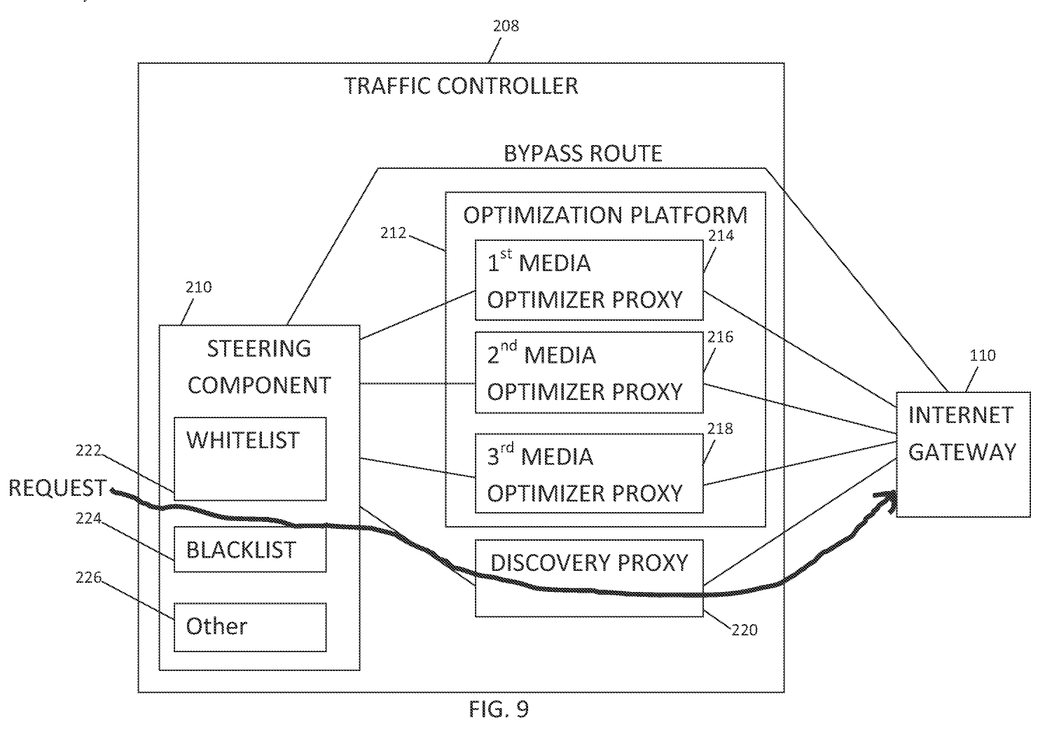

In the example illustrated in FIG. 9, the steering component 210 receives a request for content that is destined to an IP address that is not on the whitelist 222 (when there is no blacklist 224) or is destined to an IP address that is neither on the whitelist nor on an existing blacklist. In an embodiment, the request for content is destined to an IP address that is of the third category “other” 226. The steering component then checks the destination IP address of the request with addresses on the whitelist and the blacklist (if it exists), and sends the request to the discovery proxy 220. The discovery proxy transmits the request to the video content server 114 (shown in FIG. 1) or the non-video content server 116 (shown in FIG. 1) through the Internet gateway 110 and the Internet 112 (shown in FIG. 1) according to the destination IP address of the request.

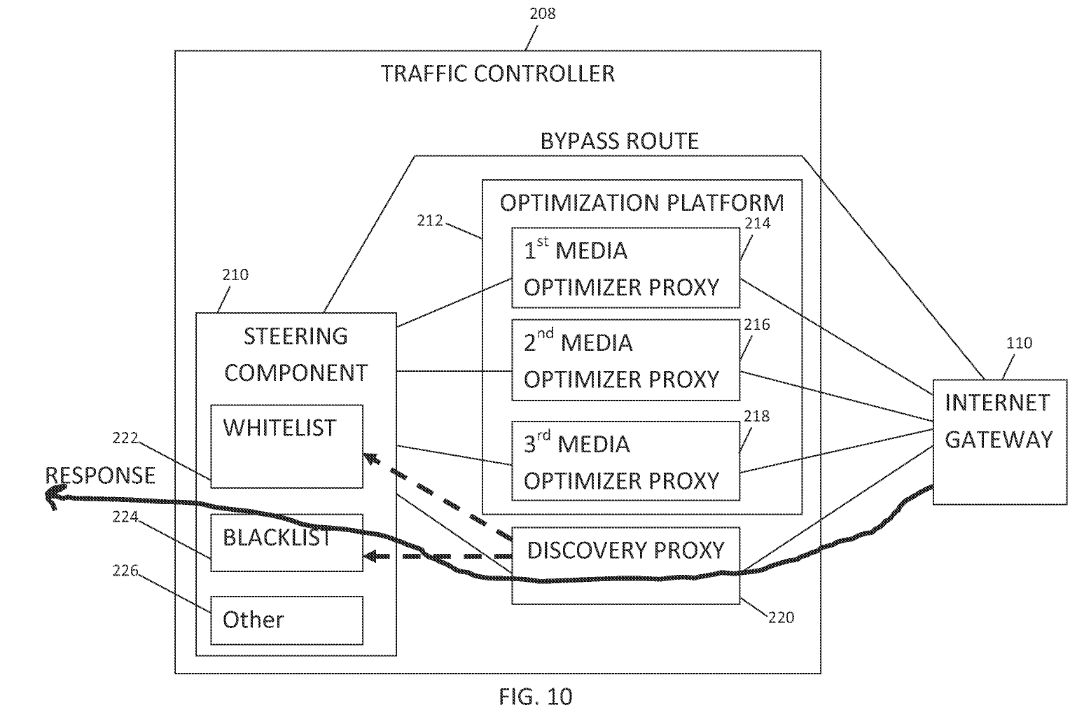

In the example illustrated in FIG. 10, the video content server 114 (shown in FIG. 1) or the non-video content server 116 (shown in FIG. 1) sends the requested content through the Internet 112 (shown in FIG. 1) to the Internet gateway 110. The Internet gateway transmits the requested content to the discovery proxy 220 in a response. The discovery proxy scans the response to determine whether or not the response contains video content. In an embodiment, the discovery proxy looks into the HTTP header of the response. For example, the discovery proxy looks at the content-type value in the HTTP header to determine whether or not the response contains video content. In another embodiment, the discovery proxy looks into the bytes of the response, such as the content-length value in the HTTP header, to determine whether or not the response contains video content. If the response is determined to include video content, then the discovery proxy updates the whitelist 222 to include the IP address of the destination IP address of the request (the IP address of the video content source). If the response does not include video content, then the discovery proxy creates a blacklist 224 or updates an existing blacklist to include the IP address of the destination IP address of the request. The response is also delivered to the mobile device 102.

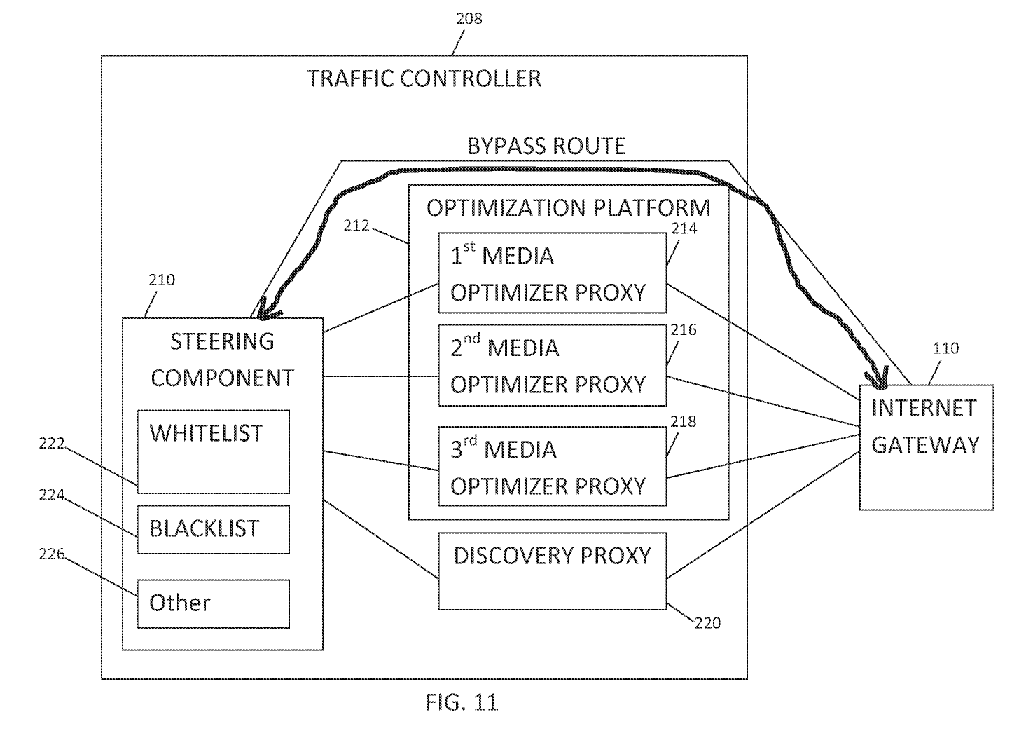

In the example illustrated in FIG. 11, the steering component 210 receives a request for content that is destined to an IP address that is on the blacklist 224, e.g., matches the destination IP address of the request with one of the addresses on the blacklist. The steering component sends the request to the Internet gateway 110 through the bypass route. The non-video content server 116 (shown in FIG. 1) sends the requested content in a response to the Internet gateway 110 through the Internet 112 (shown in FIG. 1). The Internet gateway 110 transmits the response to the steering component 210 through the bypass route for delivery to the mobile device 102. In this example, the request and the response are not optimized. As a result, only video content is optimized by the optimization platform 212.

Although the discovery proxy 220 is external to the steering component 210 in the embodiment depicted in FIG. 2, the discovery proxy may be integrated into the steering component in some embodiments. FIG. 12 depicts such an embodiment in which a traffic controller 1208 includes a steering component 1210 with an internal discovery proxy 220. Components of the traffic controller 1208 may not be included in the same device and/or in the same network. For example, the steering component and the optimization platform are included in separate network devices and/or separate networks. In another example, the first, second and third media optimizer proxies are included in separate network devices and/or separate networks.

In a static traffic steering approach, pre-configured rules are used to steer requests for delivery optimization. For example, URLs in the HTTP GET request can be used to steer requests through an optimization platform. With the fast changing Internet video content delivery landscape where hot websites and videos appear and disappear relatively quickly, pre-configured rules can become out-of-date in a short duration of time. Compared with the static traffic steering approach, the traffic controller 108 of FIG. 1, the traffic controller 208 of FIG. 2, and the traffic controller 1208 of FIG. 12 dynamically steer traffic by continuously updating the steering criteria in response to IP-based learning from actual traffic seen by the traffic controller.

In addition, compared with a traffic steering approach in which only the whitelist 222 is implemented and updated, the traffic controller 108 of FIG. 1, the traffic controller 208 of FIG. 2, and the traffic controller 1208 of FIG. 12 dynamically steer traffic by continuously updating both the whitelist and the blacklist 224. Implementing and updating only the whitelist leaves a significant portion of traffic unchecked, which leads to only a fraction of the video content being optimized, causing the value of the optimization platform 212 to be significantly diminished. However, with the traffic controller 108 of FIG. 1, the traffic controller 208 of FIG. 2, and the traffic controller 1208 of FIG. 12, more of the video content can be optimized, thereby increasing the value of the optimization platform 212 and improving the efficiency of network operators.

Although the traffic controllers 108, 208, 1208 are described above with respect to video content, the traffic controllers can also be used for the delivery optimization of other type or types of content. For example, the discovery proxy 220 can be used to detect content such as text, webpage, image, or any combination of video and non-video content by, for example, looking at the HTTP header in the HTTP response. The steering component 210, 1210 may maintain a whitelist, a blacklist and/or a third category “other” that steering criteria related to any combination of video and non-video content. The optimization platform 212 may optimize the delivery of any combination of video and non-video content.

Referring back to FIG. 1, the Internet gateway 108 of the content delivery system 100 provides a gateway for communications between the mobile device 102 and Internet-connected hosts and/or servers in the Internet 112, which can also be referred to as the “cloud.” The Internet gateway may include a Serving General Packet Radio Service (GPRS) Support Node (SGSN) and a Gateway GPRS Support Node (GGSN). For example, the Internet gateway can be a Wireless Application Protocol (WAP) gateway that converts the WAP protocol used by the radio access network to the HTTP protocol used by the Internet 112. In an embodiment, the Internet gateway enables mobile stations to access multimedia content, such as Hyper Text Markup Language (HTML), compact HTML (cHTML), and extensible HTML (xHTML), which is stored on Internet-connected hosts and/or servers. In the embodiment depicted in FIG. 1, the radio access network 104, the data gateway 106, the traffic controller 108, and the Internet gateway are located in an access network 111, which provides access to the Internet. The access network may be administered by a single entity or different entities. For example, the access network may be managed by a single Internet service provider (ISP).

The video content server 114 of the content delivery system 100 is configured to store video content, to process requests for video content from the mobile device 102, and to provide requested video content to the mobile device over at least one delivery protocol. The video content server may serve video content over a single video transport protocol or more than one video transport protocol. In an embodiment, the video content server serves video content over HTTP such as HTTP-Progressive Download (HTTP-PD) or HTTP-Adaptive Streaming (HTTP-AS), Real Time Messaging Protocol (RTMP), and/or real time streaming protocol (RTSP) or other similar protocols such as Real-time Transport Protocol (RTP) and Real Data Transport (RDT) from a content encoder or from pre-encoded content stored in a video content database (not shown). The video server may belong to a video web site, such as YouTube.com, Google Videos, Metacafe.com, and Hulu.com.

The non-video content server 116 of the content delivery system 100 is configured to store non-video content, to process requests for non-video content from the mobile device 102, to provide requested non-video content to the mobile device. The non-video content can be text, webpage, image, or any combination thereof. The non-video server may include a database (not shown) for storing non-video content. In an embodiment, the non-video content server is an HTTP server.

The video content server 114 may be physically connected to the non-video content server 116. For example, the video content server may be directly connected to the non-video content server or indirectly connected to the non-video content server through an intermediate network. The video content server may be the same as the non-video content server. For example, the video content server and the non-video content server may be located in the same physical server. In an embodiment, video content server and non-video content are distinguished by Layer 3 and Layer 4 information, e.g., IP address and port number. For example, video content is located at IP address A, port B while non-video content is located at IP address A, port C, where A represents an IP address and B and C represent different ports numbers. In another example, video content is located at IP address A, port B while non-video content is located at IP address D, port C, where A and D represent different IP addresses.

Although the operations herein are shown and described in a particular order, the order of the operations may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

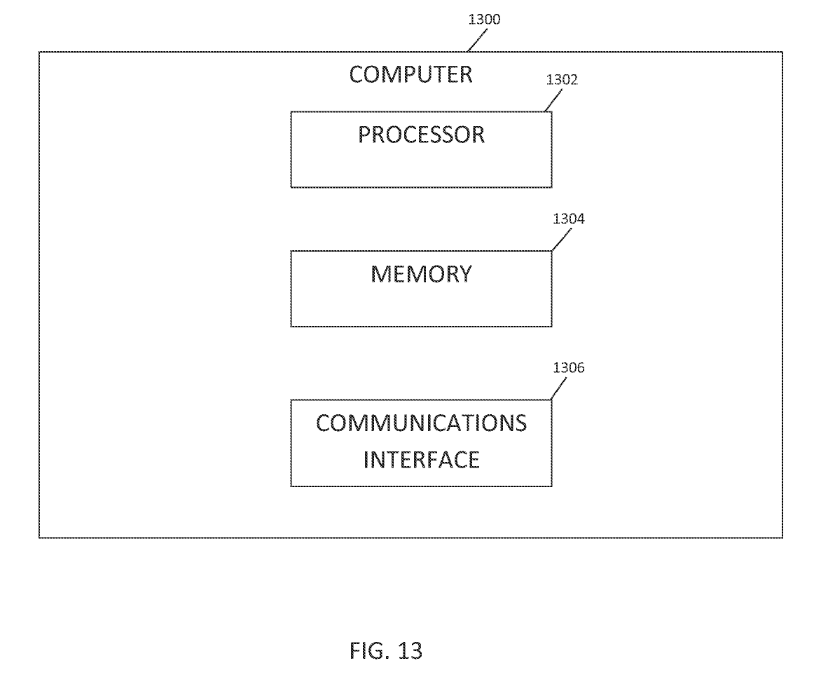

In an embodiment, at least one of the functionalities of the traffic controller 108 of FIG. 1, the traffic controller 208 of FIG. 2, and the traffic controller 1208 of FIG. 12 is performed by a computer that executes computer readable instructions. FIG. 13 depicts a computer 1300 that includes a processor 1302, memory 1304, and a communications interface 1306. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

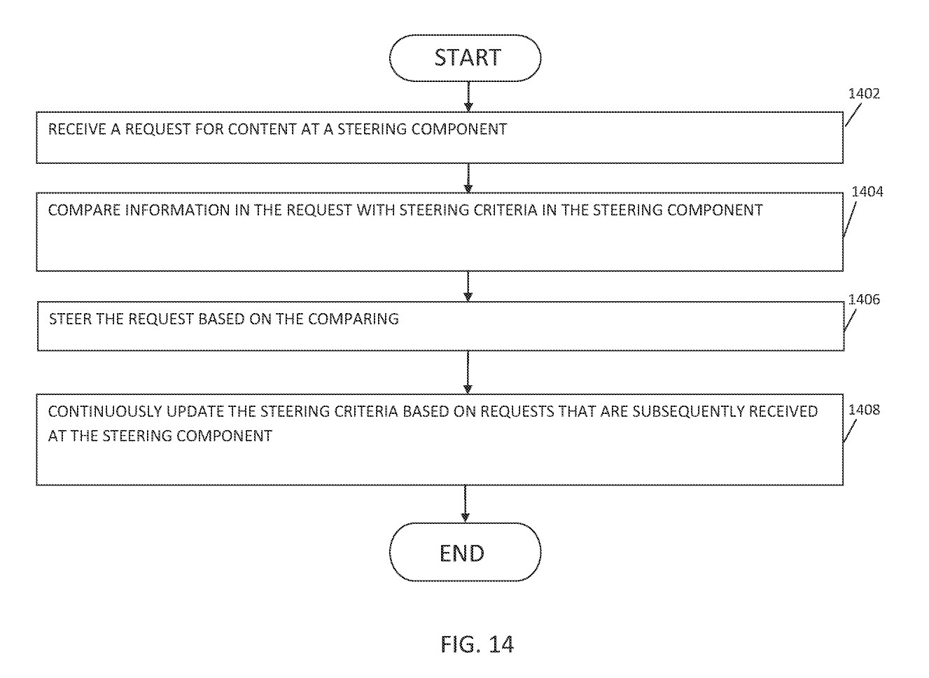

FIG. 14 is a process flow diagram of a method for dynamic traffic steering in accordance with an embodiment of the invention. At block 1402, a request for content is received at a steering component. At block 1404, information in the request is compared with steering criteria in the steering component. At block 1406, the request is steered based on the comparing. At block 1408, the steering criteria are continuously updated based on requests that are subsequently received at the steering component.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for dynamic traffic steering, the method comprising:
receiving a request for content at a steering component;
comparing information in the request with steering criteria in the steering component;
steering the request based on the comparing; and
continuously updating the steering criteria based on requests that are subsequently received at the steering component.

2. The method of claim 1, wherein comparing the information in the request with the steering criteria in the steering component comprises comparing network layer information, transport layer information, session layer information, presentation layer information, and/or application layer information in the request with the steering criteria in the steering component.

3. The method of claim 2, wherein comparing network layer information, transport layer information, session layer information, presentation layer information, and/or application layer information in the request with the steering criteria in the steering component comprises comparing the network layer information in the request with the steering criteria in the steering component.

4. The method of claim 3, wherein the steering criteria in the steering component contains information with respect to a destination of at least one request for content.

5. The method of claim 4, wherein comparing the network layer information of the request with the steering criteria in the steering component comprises comparing a destination Internet Protocol (IP) address of the request with a list of IP addresses.

6. The method of claim 5, wherein steering the request comprises sending the request for content to a discovery proxy if the destination IP address of the request is not on the list of IP addresses, wherein the method further comprises:
transmitting the request for content from the discovery proxy to a content server that is identified by the request;
receiving a response to the request from the content server at the discovery proxy;
scanning the response at the discovery proxy to determine whether or not the response contains video content; and
updating the steering criteria in response to the determination that is made by the discovery proxy.

7. The method of claim 5, wherein steering the request comprises sending the request to an optimization platform if the destination IP address of the request is on the list of IP addresses, wherein the method further comprises:
transmitting the request from the optimization platform to a video content server that is identified in the request;
receiving a response to the request from the video content server at the optimization platform; and
optimizing the response for delivery at the optimization platform.

8. The method of claim 5, wherein comparing the network layer information in the request with the steering criteria in the steering component further comprises comparing the destination IP address of the request with a second list of IP addresses if the destination IP address of the request is not on the list of IP addresses, wherein steering the request comprises transmitting the request for content through a bypass route to a content server that is identified by the request if the destination IP address of the request is on the second list of IP addresses, and the method further comprises receiving a response to the request from the video content server through the bypass route, wherein the bypass route does not include an optimization platform for content delivery optimization.

9. The method of claim 5, wherein continuously updating the steering criteria comprises updating the list of IP addresses based on the requests that are subsequently received at the steering component.

10. The method of claim 8, wherein continuously updating the steering criteria comprises updating the list of IP addresses and the second list of IP addresses based on the requests that are subsequently received at the steering component.

11. A traffic controller for dynamic traffic steering, the traffic controller comprising:
a steering component configured to maintain steering criteria for steering requests for content;
an optimization platform configured to optimize delivery of content requested by at least one of the requests for content; and
a discovery proxy configured to perform a content discovery process to update the steering criteria.

12. The traffic controller of claim 11, wherein the discovery proxy is further configured to determine whether or not content provided as a response includes content of interest in the content discovery process.

13. The traffic controller of claim 11, wherein the steering criteria are continuously updated based on the requests that are received at the steering component.

14. The traffic controller of claim 11, wherein the steering component is further configured to compare information in a request with the steering criteria and to steer the request to the optimization platform, to a bypass route that does not include the optimization platform, or to the discovery proxy based on the comparison.

15. The traffic controller of claim 14, wherein the steering criteria comprises network layer information, transport layer information, session layer information, presentation layer information, and/or application layer information.

16. The traffic controller of claim 15, wherein the steering criteria comprises network layer information.

17. The traffic controller of claim 16, wherein the steering component is further configured to compare a destination Internet Protocol (IP) address of one of the requests for content with a list of IP addresses.

18. The traffic controller of claim 17, wherein the steering component is further configured to send the request to the discovery proxy if the destination IP address of the request is not on the list of IP addresses, and wherein the discovery proxy is further configured:
to transmit the request to a content server that is identified in the request;
to receive a response to the request from the content server;
to scan the response to determine whether or not the response contains video content; and
to update the steering criteria in response to the determination.

19. The traffic controller of claim 17, wherein the steering component is further configured to send the request to the optimization platform if the destination IP address of the request is on the list of IP addresses, and wherein the optimization platform is further configured:
to transmit the request to a video content server that is identified in the request;
to receive a response to the request from the video content server; and
to optimize the response for delivery.

20. A method for dynamic traffic steering, the method comprising:
receiving a request for content at a steering component;
comparing a destination Internet Protocol (IP) address of the request with a list of IP addresses;
if the destination IP address of the request is on the list of IP addresses, sending the request to an optimization platform, transmitting the request from the optimization platform to a content server that is identified in the request, receiving a response to the request from the content server at the optimization platform, and optimizing the response for delivery at the optimization platform;
if the destination IP address of the request is not on the list of IP addresses, sending the request to a discovery proxy, transmitting the request for content from the discovery proxy to the content server that is identified by the request, receiving the response to a request from the content server at the discovery proxy, scanning the response at the discovery proxy to determine whether or not the response contains video content, and updating the steering criteria in response to the determination that is made by the discovery proxy; and
continuously updating the steering criteria based on requests that are subsequently received at the steering component.
